(19) United States
(12) Patent Application Publication
(10) Pub. No.: US 2021/0373202 A1
(43) Pub. Date: Dec. 2, 2021

(54) GEOMETRIC PHASE AND OFF-AXIS OPTICS FOR REDUCED BACKSCATTER

(71) Applicant: LOCKHEED MARTIN CORPORATION, Bethesda, MD (US)

(72) Inventor: Joseph Robert BUCK, JR., Superior, CO (US)

(21) Appl. No.: 16/889,706

(22) Filed: Jun. 1, 2020

(51) Int. Cl. G02B 1/11; G02B 27/30; G02F 1/31; G02F 2/00

(52) U.S. Cl. CPC G02B 1/11; G02F 2/00; G02F 1/31; G02B 27/30

(57) ABSTRACT

An off-axis optical system includes an optical source to generate a light beam and an off-axis optical element arranged at a first angle with respect to a normal to the light beam. The off-axis optical element deflects the light beam onto a target. The off-axis optical element can be a thin-film reflective element having a combined deflection and lens profile.

### STATEMENT REGARDING FEDERALLY SPONSORED RESEARCH OR DEVELOPMENT

Not applicable.

### FIELD OF THE INVENTION

The present invention generally relates to optical systems and, more particularly, to geometric phase and off-axis optics for reduced backscatter

### BACKGROUND

Part of the design trade for active optical systems involves the impact of backscatter from the primary optics into the receiver as a background. Anti-reflection coatings may be insufficient for reducing this background. For example, for coherent systems, the primary optic backscatter may set the recovery time for the earliest recoverable range bin. For direct-detection systems, the backscatter may also impact the recoverable range bins. For Geiger-mode receivers, the primary optic backscatter may make many measurement protocols impractical. The primary optic backscatter often drives the use of a bistatic off-axis reflector design.

### SUMMARY

According to various aspects of the subject technology, methods and configurations are provided for development of canted optics to reduce backscatter by leveraging advances in the field of thin-film optics. The subject technology allows implementations with both monostatic and bistatic designs for catoptric, dioptric, and catadioptric configurations of coherent and direct-detection systems. The designs of the subject technology are not symmetric, so they have become practical with the recent advances in the thin-film optics work.

In one or more aspects, an off-axis optical system includes an optical source to generate a light beam, and an off-axis optical element arranged at a first angle with respect to a normal to the light beam. The off-axis optical element deflects the light beam onto a target. The off-axis optical element can be a thin-film reflective element having a combined deflection and lens profile.

In other aspects, a remote sensing system based on off-axis optics includes an optical transmitter that generates a transmit (TX) light beam, and an optical switch that directs the TX light beam to an off-axis optical element. The off-axis optical element can deflect the TX light beam onto a target.

In yet other aspects, a method includes generating a light beam, setting up an off-axis optical element at a first angle with respect to a normal to the light beam and configuring the off-axis optical element to deflect the light beam onto a target.

The foregoing has outlined rather broadly the features of the present disclosure so that the following detailed description can be better understood. Additional features and advantages of the disclosure, which form the subject of the claims, will be described hereinafter.

### BRIEF DESCRIPTION OF THE DRAWINGS

For a more complete understanding of the present disclosure and the advantages thereof, reference is now made to the following descriptions to be taken in conjunction with the accompanying drawings describing specific aspects of the disclosure, wherein:

FIGS. 1A, 1B and 1C are schematic diagrams illustrating examples of phase profiles for lens and off-axis lens, according to certain aspects of the disclosure.

FIG. 2 is a schematic diagram illustrating an example of a collimation setup using a reflective element for beam-expander applications, according to certain aspects of the disclosure.

FIGS. 3A, 3B and 3C are schematic diagrams of configurations for a two-element thin-film optic beam expander, according to certain aspects of the disclosure.

FIGS. 4A, 4B and 4C are schematic diagrams illustrating examples of applications of the off-axis optics, according to certain aspects of the disclosure.

FIG. 5 is a chart illustrating an example of a reduction of backscattered light for an active system as a function of the optic tilt angle, according to certain aspects of the disclosure.

FIGS. 6A, 6B, 6C and 6D are charts illustrating examples of early range bin retrieval for a coherent-detection system, according to certain aspects of the disclosure.

FIG. 7 is a flow diagram illustrating a method of using a reflective element for beam-expander applications, according to certain aspects of the disclosure.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and can be practiced using one or more implementations. In one or more instances, well-known structures and components are shown in block diagram form in order to avoid obscuring the concepts of the subject technology.

In some aspects of the present technology, methods and configurations are provided for development of canted optics by leveraging advances in the field of thin-film optics to reduce backscatter. The subject technology allows implementations with both monostatic and bistatic designs. These designs can be applied for catoptric, dioptric, and catadioptric configurations in both coherent and direct-detection systems. The designs of the subject technology have become practical with the recent advances in the thin-film optics work, as these designs may not be rotationally symmetric. The disclosed optical systems can be canted from normal to the imaging axis in order to significantly reduce the backscatter into the mode of interest. The off-axis optical elements of the subject technology can be thin-film optic based and can also be implemented using spatial light modulators including liquid crystal-based and micro-electromechanical system (MEMS) mirror-based systems, as well as metamaterial-based optics. For the geometric phase mesogen-based approach, the optic can be tilted up, for example, to about 60 degrees from normal.

The subject technology can be applied in a number of optical systems, for example, in a planar, off-axis transmissive optical system, in a planar, off-axis reflective optical system, in a direct detection system with a specific high-repetition waveform and in coherent-detection systems with early range bin retrieval and specific high-repetition waveform. The disclosed technology can be applied to backscatter suppression trade versus cant angle from normal.

Conventional optics use a varying spatial profile with either distance or varying distance through a material with a different index of refraction to impart a spatial profile of phase on a wavefront. This is true for both transmissive and reflective optics. While there has been much progress in improving manufacturing techniques, the same methods of manufacturing optical elements employed over hundreds of years are still being used. While some newer materials allow for higher index of refraction with higher transmission than was possible in the past, similar manufacturing constraints and mass production requirements remain as they have for the past several decades.

In order to mitigate backscatter from the primary optics, most existing solutions are constrained to bistatic implementations. For monostatic configurations, the existing solutions are limited to multielement, off-axis reflective designs. For many direct-detection systems, this often results in one of the most stringent system requirements in practical implementations. The subject technology changes the existing trade and allows implementations with both monostatic and bistatic designs for catoptric, dioptric, and catadioptric coherent and direct-detection systems. The disclosed solution enables practical designs with a single element, off-axis optics for both bistatic and monostatic configurations to be used in both direct-detection and coherent-detection system implementations. Further, the designs of the subject technology allow for an expanded application of monostatic optical system implementations such as a monostatic ladar, in which the transmitter and receiver are collocated.

One or more implementations of the present disclosure provide a method of manufacturing a thin film optical apparatus, including providing a substrate and applying an alignment layer over the substrate. The alignment layer may range from about 50 to 100 nm in thickness. The method may further include imprinting a hologram with a desired optic pattern onto the alignment layer and applying at least one layer of mesogen material over the alignment layer. The optical apparatus may range in the order of about one-half to one wavelength thick.

In some implementations, the subject technology provides a method of the manufacturing of an optical apparatus, including providing a substrate and applying at least one alignment layer above the substrate. The method may further include writing a polarization phase hologram into the at least one alignment layer to impart the phase transformation of a desired optical pattern, and applying at least one layer of birefringent material over the alignment layer. The optical apparatus may range in the order of one-half to one wavelength in thickness.

Additional configurations to provide an off-axis optical element can be realized by using a phase-based spatial light modulator to generate the desired phase pattern. However, these devices have limited resolution that makes them less desirable than the mesogen-based implementation. Other implementations can be realized with metamaterials for the optical domain, or deformable mirrors, as the capabilities of these materials advance.

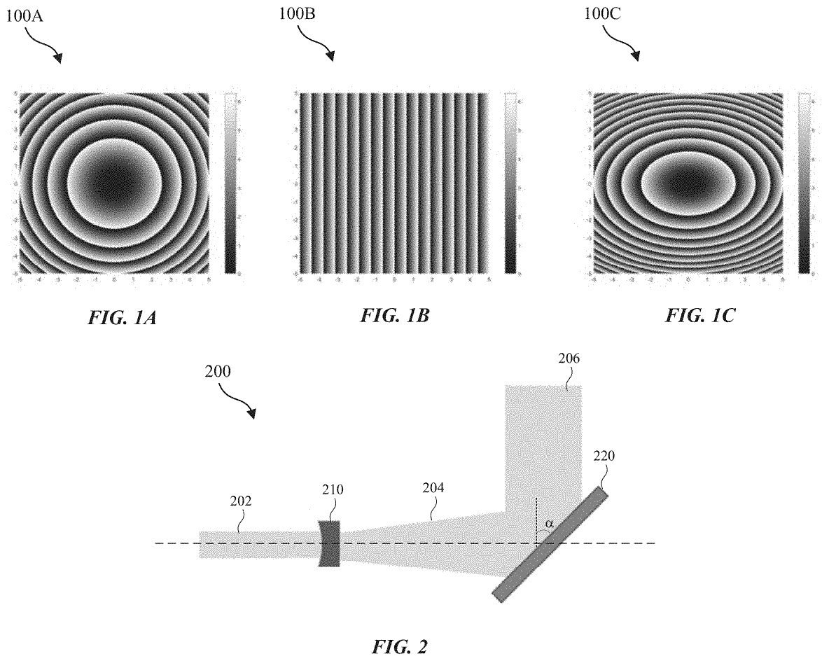

FIGS. 1A, 1B and 1C are schematic diagrams illustrating examples of phase profiles 100A, 100B and 100C for lens and off-axis lens, according to certain aspects of the disclosure. The phase profile 100A corresponds to an example spherical lens in thin-film optics. The thin-film spherical lens provides a focal point set by the parabolic profile for the phase. The phase profile 100A is represented by a wrapping of 27c radians in the shown plot.

The phase profile 100B corresponds to an example uniform deflection angle in thin-film optics with the phase wrapped to 27c radians. The thin-film uniform deflection angle provides a deflection for either reflective or transmissive optics.

The phase profile 100C corresponds to an example of a combination of a lens profile and a uniform deflection angle in thin-film optics. The combination results in an off-axis lens profile that compensates for the tilt of the substrate.

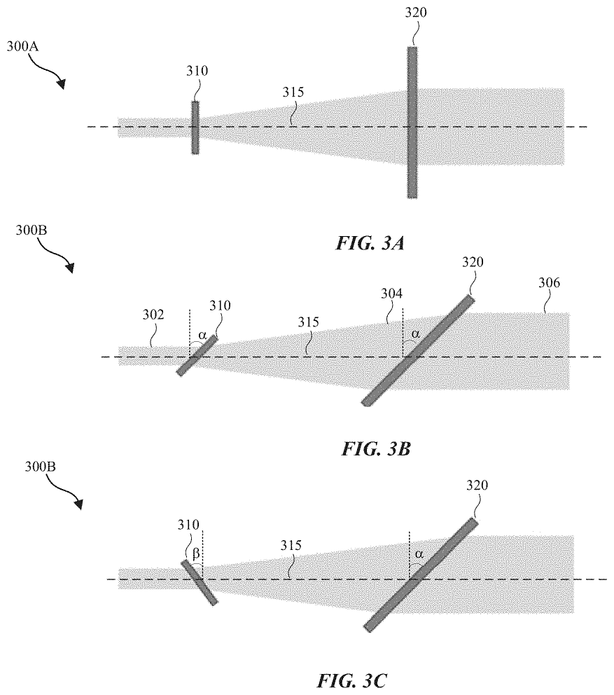

FIG. 2 is a schematic diagram illustrating an example of a collimation setup 200 using a reflective element for beam expander applications, according to certain aspects of the disclosure. The collimation setup 200 is a collimated beam expander and includes an optical element 210 (e.g., a diverging lens) and a reflective element 220. In some implementations, the optical element 210 can be negative plano-concave lens. The optical element 210 diverges the incoming optical beam 202 into a beam 204 that is deflected by the reflective element 220, which is an off-axis reflector, to form the collimated beam 206. The reflective element 220 is a thin-film reflective element with a combined deflection and lens profile and is set up at angle α with respect to a normal to an axis of the incoming beam 202. In the collimation setup 200, the magnification is set by the relative focal lengths of the optical element 210 and the lens profile of the reflective element 220.

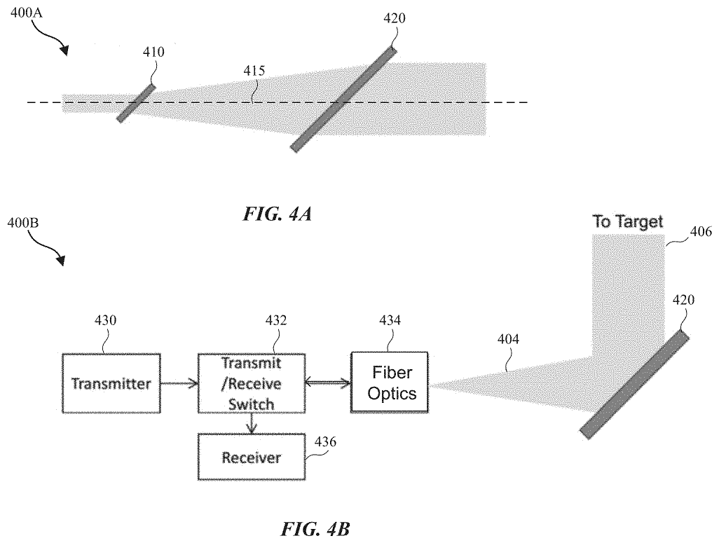

FIGS. 3A, 3B and 3C are schematic diagrams of example configurations 300A, 300B and 300C for a two-element thin-film optic beam expander, according to certain aspects of the disclosure. The configuration 300A is an example beam expander, including a first optical element 310 and a second optical element 320, which are thin-film optical elements formed on two substrates. In the configuration 300A, the substrates of the first and second optical elements 310 and 320 are configured at normal incidence to the beam path 315, which matches the typical configuration for traditional optics. In the configuration 300A, the first optical element 310 is a negative lens that expands an incoming beam 302 into a wider beam 304, while the second optical 320 is a reflector element with an embedded positive lens that recollimates the wider beam 304 to form the output beam 306.

The configuration 300B is an example beam expander, including the first optical element 310 and the second optical element 320 formed, as thin-film optical elements, on two substrates. In the configuration 300B, the substrates of the first and second optical elements 310 and 320 are tilted at an angle α with respect to the beam path 315, which removes the need for normal incidence that the traditional optical configurations are restricted to. In the configuration 300B, similar to the configuration 300A, the first optical element 310 is a negative lens and the second optical element 320 is a reflector element with an embedded positive lens. The configuration 300B enables a significant reduction of the backscattered light as compared to a traditional optical setup. In the example configuration 300B, the substrates of the first and second optical elements 310 and 320 are tilted equally, by an angle α, in the same direction.

The configuration 300C is an example beam expander, including the first optical element 310 and the second optical element 320 formed, as thin-film optical elements, on a first and a second substrate, respectively. In the configuration 300C, the first substrate of the first optical element 310 is tilted at an angle β with respect to the beam path 315, while the second substrate of the second optical element 320 is tilted at an angle α with respect to the beam path 315. The tilt angles α and β are at different directions. In the configuration 300C, similar to the configuration 300B, the first optical element 310 is a negative lens and the second optical element 320 is a reflector element with an embedded positive lens. The configuration 300C enables a significant reduction of the backscattered light as compared to a traditional optical setup. Further, the configuration 300C provides an additional benefit of reducing beam walk-off errors in the optical beams.

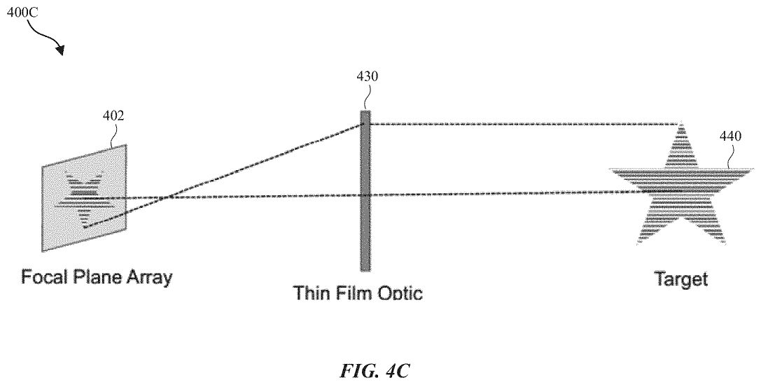

FIGS. 4A, 4B and 4C are schematic diagrams illustrating examples of applications of the off-axis optics, according to certain aspects of the disclosure. FIG. 4A shows a configuration 400A of a two-element thin-film optic beam expander similar to the configuration 300B of FIG. 3, described above. The setup of the configuration 400A includes a first optical element 410 and a second optical element 420 at a tilt angle (e.g., α) with respect to the beam axis 415. The setup of the configuration 400A can be applied to a telescope for transmit beams, imaging systems, or optical system relay configurations.

FIG. 4B shows a block diagram of an example of an off-axis optical setup 400B for remote sensing, which includes a transmitter 430, a transmit/receive switch 432, a receiver 436, fiber optics 434 and the second optical element 420. The transmitter 430 may include a laser source that provides a source light to the transmit/receive switch 432, which directs a transmit beam to the fiber optics 434. In one or more implementations, the transmitter 430 may include other components, such as an optical modulator. The fiber optics 434 provides a diverging fiber beam 404 that is reflected by the second optical element 420. The second optical element 420 can be an off-axis reflector element with an embedded positive lens that is used as a collimator for the fiber beam 404. In a receive path, a return beam 406 from the target is reflected and focused, by the second optical element 420, into the fiber optics 434 and then directed by the transmit/receive switch 432 onto the receiver 436. In some implementations, the receiver 436 includes an optical detector and can produce an electrical signal associated with the target. In one or more implementations, the receiver 436 may include additional components, such as an optical demodulator.

FIG. 4C shows a block diagram of an example of an optical setup 400C for passive imaging. The optical setup 400C includes a thin-film optical element 430 and a focal plane array 402 used to provide an image of a target 440. The thin-film optical element 430 is arranged to relay the light from the target 440 to the focal plane array 402. In one or more implementations, the thin-film optical element 430 can be off-axis, for example, at an angle with respect to the beam axis.

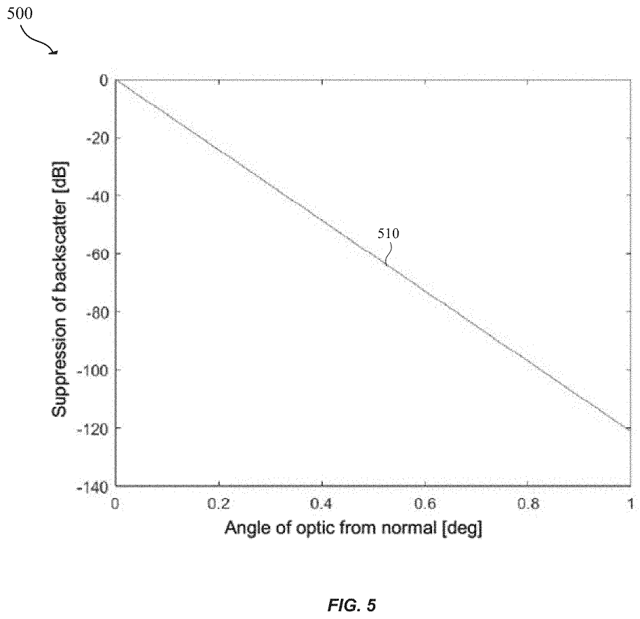

FIG. 5 is a chart illustrating an example plot 510 of reduction of backscattered light for an active system as a function of the optic tilt angle, according to certain aspects of the disclosure. The reduction of the backscattered light is shown in dB as a backscattered amplitude suppression. The example plot 510 is for a 1 mm diameter collimated beam that is 10 cm from the collimating optic. In this example, the level of backscattering due to residual surface reflection is significantly reduced at just one degree tilt (e.g., a of FIG. 3) from normal. The level of backscattering depends on the beam profile and geometric dimensions and distances for the optical modes involved.

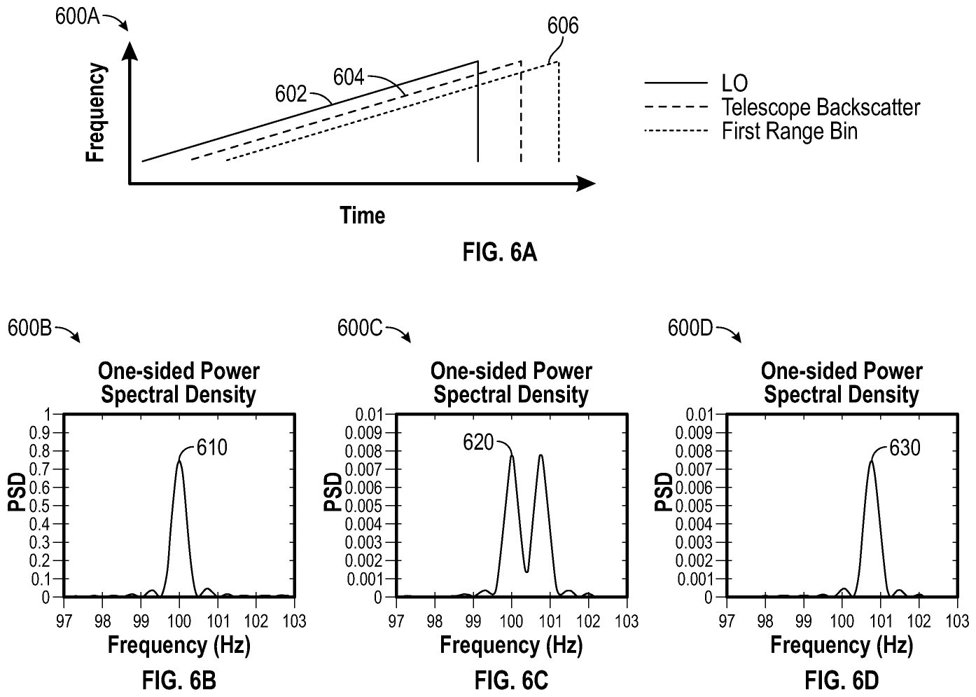

FIGS. 6A, 6B, 6C and 6D are charts 600A, 600B, 600C and 600D illustrating examples of early range bin retrieval for a coherent detection system, according to certain aspects of the disclosure. The chart 600A shows plots 602, 604 and 606, which depict frequency-versus-time variation of frequency chirped signals of a local oscillator (LO), a telescope backscatter, and a returned signal from a nearby range bin, respectively. Because the frequency is chirped linearly, the mixing of the LO with the returned light results in a constant frequency that scales with the range to the scattering object. When the range bins are close together, a large signal will mask a smaller one, so that weaker signals must be much farther away from a strong signal to be seen. This shows the importance of reducing backscatter from the telescope to prevent it from hiding weak signals at close range.

The chart 600B shows a plot 610 of the power spectral density (PSD) of the resulting signal for the telescope at 100 Hz, which is 100 times larger than the close scatterer at a frequency of 100.75 Hz.

The chart 600C shows a plot 620 of the PSD of the resulting signals when the telescope backscatter is reduced by a factor of 100. In this case, both signals are able to be seen, since the scatterer is not masked by the sidelobes from the telescope.

The chart 600D shows a plot 630 of the PSD of the resulting signal when the telescope backscatter is reduced by a factor of 1000, which is an additional 10 times over what was shown by the chart 600C. In this case, the telescope is not visible because the desired signal from the nearby scatterer is larger.

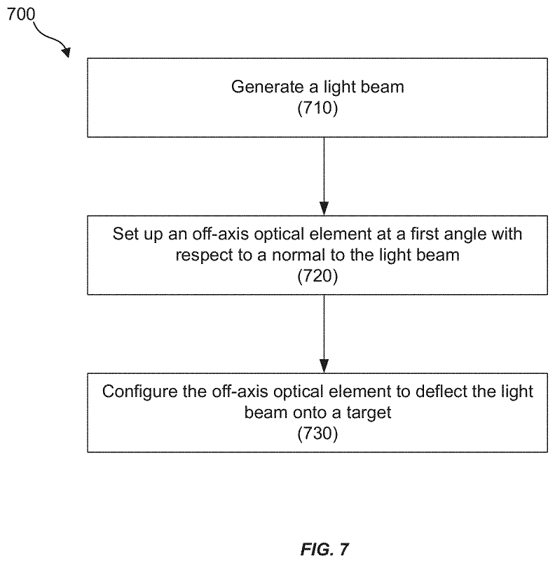

FIG. 7 is a flow diagram illustrating a method 700 of using a reflective element for beam-expander applications, according to certain aspects of the disclosure. The method 700 includes generating a light beam (e.g., 202 of FIG. 2) (710) and setting up an off-axis optical element (e.g., 220 of FIG. 2) at a first angle (e.g., a of FIG. 2) with respect to a normal to the light beam (720). The method 700 further includes configuring the off-axis optical element to deflect the light beam (e.g., 206 of FIG. 2) onto a target (730).

In some aspects, the subject technology is related to methods and configurations for development of canted optics to reduce backscatter by leveraging advances in the field of thin-film optics. In some other aspects, the subject technology may be used in various markets, including, for example, and without limitation, advanced materials, optical communication, remote sensing and imaging markets.

Those of skill in the art would appreciate that the various illustrative blocks, modules, elements, components, methods, and algorithms described herein may be implemented as electronic hardware, computer software or a combination of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks may be performed. Any of the blocks may be performed simultaneously. In one or more implementations, multitasking and parallel processing may be advantageous. Moreover, the separation of various system components in the embodiments described above should not be understood as requiring such separation in all embodiments, and it should be understood that the described program components and systems can generally be integrated together in a single hardware and software product or packaged into multiple hardware and software products.

The description of the subject technology is provided to enable any person skilled in the art to practice the various aspects described herein. While the subject technology has been particularly described with reference to the various figures and aspects, it should be understood that these are for illustration purposes only and should not be taken as limiting the scope of the subject technology.

A reference to an element in the singular is not intended to mean “one and only one” unless specifically stated, but rather “one or more.” The term “some” refers to one or more. All structural and functional equivalents to the elements of the various aspects described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

Although the invention has been described with reference to the disclosed aspects, one having ordinary skill in the art will readily appreciate that these aspects are only illustrative of the invention. It should be understood that various modifications can be made without departing from the spirit of the invention. The particular aspects disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative aspects disclosed above may be altered, combined, or modified and all such variations are considered within the scope and spirit of the present invention. While compositions and methods are described in terms of “comprising,” “containing,” or “including” various components or steps, the compositions and methods can also “consist essentially of” or “consist of” the various components and operations. All numbers and ranges disclosed above can vary by some amount. Whenever a numerical range with a lower limit and an upper limit is disclosed, any number and any subrange falling within the broader range are specifically disclosed. Also, the terms in the claims have their plain, ordinary meanings unless otherwise explicitly and clearly defined by the patentee. If there is any conflict in the usage of a word or term in this specification and one or more patent or other documents that may be incorporated herein by reference, the definition that is consistent with this specification should be adopted.

What is claimed is:

1. An off-axis optical system, the system comprising:
an optical source configured to generate a light beam; and
an off-axis optical element arranged at a first angle with respect to a normal to the light beam,
wherein the off-axis optical element is configured to deflect the light beam onto a target.

2. The system of claim 1, wherein the off-axis optical element comprises a thin-film reflective element having a combined deflection and lens profile.

3. The system of claim 1, further comprising a diverging optical element configured to diverge and direct the light beam onto the off-axis optical element.

4. The system of claim 3, wherein the diverging optical element comprises a negative lens arranged at a second angle with respect to the normal to the light beam.

5. The system of claim 4, wherein the first angle is equal and with a same direction as the second angle.

6. The system of claim 4, wherein the first angle has a different direction from the second angle.

7. The system of claim 1, wherein the off-axis optical element is configured to suppress backscattered light.

8. The system of claim 7, wherein a change of the first angle allows variation of a level of suppression of the backscattered light.

9. A remote sensing system based on off-axis optics, the system comprising:
an optical transmitter configured to generate a transmit (TX) light beam; and
an optical switch configured to direct the TX light beam to an off-axis optical element,
wherein the off-axis optical element is configured to deflect the TX light beam to a target.

10. The system of claim 9, further comprising fiber optics coupled to the optical switch and configured to guide the TX light beam to the off-axis optical element.

11. The system of claim 10, wherein the fiber optics comprises optical fiber and one or more optical elements.

12. The system of claim 10, wherein the off-axis optical element is further configured to collimate a return light beam from the target into the fiber optics.

13. The system of claim 12, wherein the optical switch comprises a transmit/receive switch and is configured to direct the return light beam to a receiver.

14. The system of claim 13, wherein the receiver is configured to receive the return light beam and generate an electrical signal corresponding to optical characteristics of the target.

15. The system of claim 14, wherein the TX light beam comprises a modulated light beam.

16. The system of claim 14, wherein the receiver further comprises a demodulator configured to demodulate the received return light beam.

17. The system of claim 9, wherein the off-axis optical element comprises a thin-film reflective element having a combined deflection and lens profile.

18. A method comprising:
generating a light beam;
setting up an off-axis optical element at a first angle with respect to a normal to the light beam; and
configuring the off-axis optical element to deflect the light beam onto a target.

19. The method of claim 18, wherein the off-axis optical element comprises a thin-film reflective element having a combined deflection and lens profile, wherein the off-axis optical element is configured to suppress backscattered light, and wherein a change of the first angle allows variation of a level of suppression of the backscattered light.

20. The method of claim 18, further comprising diverging and directing the light beam onto the off-axis optical element by using a diverging optical element, wherein the diverging optical element comprises a negative lens arranged at a second angle with respect to the normal to the light beam, and wherein the first angle is equal and with a same direction as the second angle.
